(19) United States
(12) Patent Application Publication
(10) Pub. No.: US 2007/0266370 A1
(43) Pub. Date: Nov. 15, 2007

(54) Data Plane Technology Including Packet Processing for Network Processors

(76) Inventors: Glenford J. Myers, Portland, OR (US); Curtis A. Schwaderer, Urbandale, IA (US); Michael T. Imel, Portland, OR (US); Kevin L. Graves, Beaverton, OR (US); David T. Cassing, Aurora, OR (US)

Correspondence Address: PAUL J. FORDENBACHER;SILICON FOREST PATENT GROUP, 11876 NW TYLER CT., PORTLAND, OR, 97229, US

(21) Appl. No.: 11/575,217

(22) PCT Filed: Sep. 16, 2005
(86) PCT No.: PCT/US05/33146

§ 371 Date: Mar. 14, 2007

Related U.S. Application Data
(60) Provisional application No. 60/611,137, filed on Sep. 16, 2004.

(51) Int. Cl. G06F 9/455

(52) U.S. Cl. 717/119

(57) ABSTRACT

The present invention provides methods and apparatus for abstracting network processors using a virtual machine. The virtual machine approach substantially abstracts the network processor, letting the application developer focus all attention on packet processing. In accordance with the present invention, the NPU-based virtual machine provides the functionality of a pipelined engine, N-way parallelism, or both. The present invention provides a high-level functional language for expressing a wide variety of packet processing applications. The high-level functional language provides primitives in the form of instructions such as, but not limited to, tracking a connection or session, removing an outer header, translating an IP address, encrypting a packet, and scanning the payload for a regular expression.

### RELATED APPLICATION

This is a non-provisional patent application claiming benefit under 35 USC § 119(e) of claiming priority to Provisional application No. U.S. 60/611,137, filed on Sep. 16, 2004, which is in its entirety incorporated herewith by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright, 2005, IP Fabrics, Inc.

### FIELD OF THE INVENTION

The present invention is related to programming network processors, and more particularly, to methods and apparatus for abstracting network processors with a virtual machine.

### BACKGROUND

As the demands of carrier and enterprise networks have become increasingly multidimensional in attributes of performance, functionality, and extensibility, network processing units (NPU), also referred to as network processors, are increasingly replacing alternative solutions such as application-specific ASICs and general-purpose processors. A network processor is a programmable device that has been designed and optimized to perform networking functions. The network processor is designed to have an optimized instruction set, peripheral interfaces, multiple processors and multiple contexts, that is, hardware multi-threaded, all of which particularly suitable for packet processing. However, the very strength of network processors, being a “soft” solution via software, is also the key challenge in deploying network processors.

A known NPU has many parallel low-level RISC-type processors that need to be programmed by a software developer, also referred to as a programmer. Commonly, these processors have one or more types of low-level, software-managed interconnects among themselves, have an instruction-set architecture, address different types of on-chip and off-chip memories, have a very limited instruction space, and do not have an operating system. Complicating the environment further, the NPUs may have hardware-controlled context threading and the software may have to deal with on-chip and off-chip specialized modules, such as TCAMs, CRC units, hash units, cipher engines, and classification hardware.

The result is that the complexity facing the NPU programmer can be several orders of magnitude greater than if writing software for the typical general-purpose processor. Although NPU manufacturers provide a subset C language in addition to assembly language, C-written NPU software tends to look much like assembly or machine code because the program needs to deal with specifics of the NPU and because there are no libraries and operating system to support it.

Network processors represent a powerful technology capable of serving as the core of next-generation networking equipment, bringing such equipment both high wire-speed performance and the benefits of a software-centric implementation. New approaches to the difficult task of producing NPU software are needed to make significant improvements in development cost, time to market, extensibility, and scalability and to make harnessing the power of NPUs a more achievable objective.

### BRIEF DESCRIPTION OF THE DRAWINGS

Like reference numbers generally indicate corresponding elements in the figures.

FIG. 1 illustrates a system comprising a packet processing language (PPL) program, a PPL compiler adapted for interpreting the PPL program into PPL bytecode, and a virtual machine for implementation of the PPL bytecode on a network processing unit (NPU), in accordance with an embodiment of the present invention;

FIG. 2 shows the PPL as a structure comprising a high-level language including rules, events and policies for describing the processing of network packets adapted for implementation on a network processor, in accordance with an embodiment of the present invention;

FIG. 3 illustrates multiple events each having multiple rules executed within the PPL Program on multiple processors, in accordance with an embodiment of the present invention;

FIG. 4 is a schematic of the PPL Virtual Machine pipeline, in accordance with an embodiment of the present invention;

FIG. 5 illustrates a system-level solution from the creation and compilation of the PPL bytecode on a computer to the implementation of the PPL bytecode on the PPL virtual machine controlling the NPU, as associated with XScale and CPU type processors, in accordance with an embodiment of the present invention;

FIG. 6 illustrates the PPL virtual machine architecture including packet flows, components, and component interfaces, in accordance with an embodiment of the present invention;

FIGS. 7 and 8 are two embodiments of methods for writing and compiling PPL programs, in accordance with the present invention; and

FIG. 9 is a table containing a summary of the steps, the appropriate commands/actions within those steps and the systems on which the steps are executed, in accordance with an embodiment of the present invention.

### DETAILED DESCRIPTION

In the following detailed description of the embodiments, reference is made to the accompanying drawings which form a part hereof, and in which is shown by way of illustration specific embodiments in which the inventions may be practiced. These embodiments are described in sufficient detail to enable those skilled in the art to practice the invention, and it is to be understood that other embodiments may be utilized and that structural, logical and electrical changes may be made without departing from the spirit and scope of the present inventions. The following detained description is, therefore, not to be taken in a limiting sense, and the scope of the present inventions is defined only by the appended claims.

Embodiments of the present invention relate to network processors and to network processors within computer systems. Some embodiments further relate to machine readable media on which are stored the layout parameters of the present inventions and/or program instructions for using the present invention in performing operation on a network processor(s) and computer systems with network processor(s). Such media includes by way of example magnetic tape, magnetic disks, and optically readable media such as CD ROMS, DVD ROMS, and semiconductor memory such as PCMCIA cards and flash drives. The medium may also take the form of a portable item such as a disk, diskette or cassette. The medium may also take the form of a lager or immobile item such as a hard disk drive or a computer RAM or ROM.

As used herein, bytecode is computer code that is processed by a program, referred to as a virtual machine, rather than by the “real” computer machine, the hardware processor. The virtual machine converts each generalized machine instruction into a specific machine instruction or instructions that the computer's processor will understand. Bytecode is the result of compiling source code written in a language that supports this approach.

As used herein, packets and packet-switched refers to a type of network in which relatively small units of data called packets are routed through a network based on the destination address contained within each packet. Breaking communication down into packets allows the same data path to be shared among many users in the network. This type of communication between sender and receiver is known as connectionless, as opposed to dedicated. Most traffic over the Internet uses packet switching and the Internet is basically a connectionless network.

The specification for the Packet Processing Language referred herein can be found at www.IPFabrics.com, entitled PPL Packet Processing Language, dated Jun. 24, 2005, which is hereby incorporated herein by reference for all purposes.

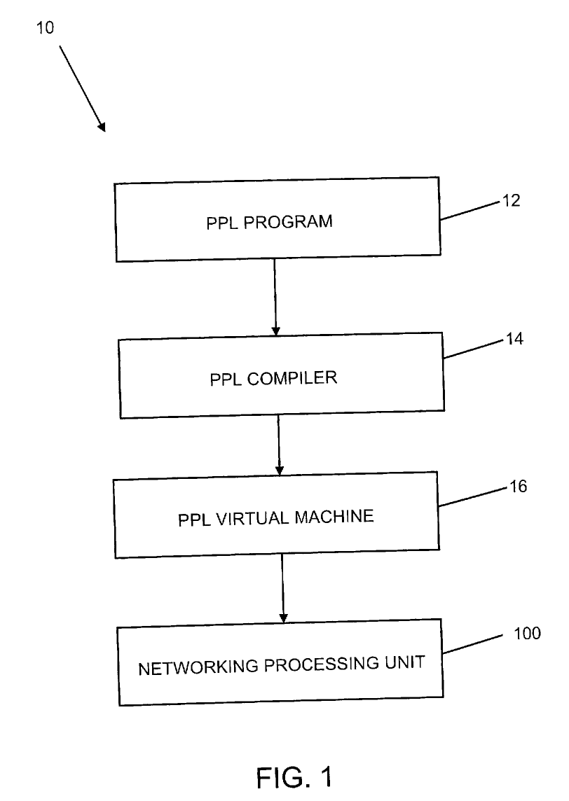

FIG. 1 illustrates a system 10 comprising a packet processing language (PPL) program 12, a PPL compiler 14 adapted for interpreting the PPL program 12 into PPL bytecode, and a virtual machine 16 for implementation of the PPL bytecode on a network processing unit (NPU) 100, also referred to network processor, in accordance with an embodiment of the present invention. The PPL program 12 comprises a high-level language, referred to as packet processing language (PPL), which comprises rules, events and policies for describing the processing of network packets. The PPL virtual machine (VM) 16 is adapted to process or interpret the rules, events and policies in binary code understandable by a specific NPU 100. The PPL is a highly effective language for the development of NPU data-plane software with the virtual machine manifestation interpreting the resulting PPL program 12 for use by a particular NPU 100 or NPU family.

The virtual machine 16 interprets the application logic and the compiler 14 translates programs written in PPL bytecode into the virtual machine representation binary code. This approach abstracts the network processor 100, allowing the programmer to focus attention on creating applications for packet processing and not the particulars of a specific NPU 100. The PPL 12 contains functionality to, such as, but not limited to, process layer 3 IP packets, specific protocols at layer 4 (e.g., TCP and UDP), and is highly optimized for “deep” packet processing at layers 5-7. It has a plurality of “built-in” algorithms/state machines orientated toward complex packet processing applications such as, but not limited to, encryption, authentication, content inspection, stateless and stateful firewall filtering, detection of intrusions and denial-of-service attacks, layer 7 filtering, traffic management, and content-based load balancing. The virtual machine provides a high amount of concurrency and parallelism. This attribute is highly beneficial, as will be discussed below.

The PPL is adapted to hide the details and complexities of the underlying network processor(s) such that the development effort and time of NPU-based networking applications by software programmers and developers is greatly reduced as compared with programming in machine language or other low-level languages like C and C++.

The PPL is applications focused; in other words, the PPL provides representations of the functions of networking applications. For example, elements of the PPL comprise concepts as packets, connections, encryption, and signature searching, among others, as contrasted with programming languages that provide abstractions of the underlying machine instruction set.

The PPL is packet centric. The fundamental data structure in PPL is a packet. Many of the “operators” in PPL perform operations on a packet. PPL provides strong type checking on packets. For example, it is impossible to refer beyond the extent of a packet, refer to arbitrary memory as a packet, do an IP operation on a non-IP packet, or refer to an IPv6 address in an IPv4 packet.

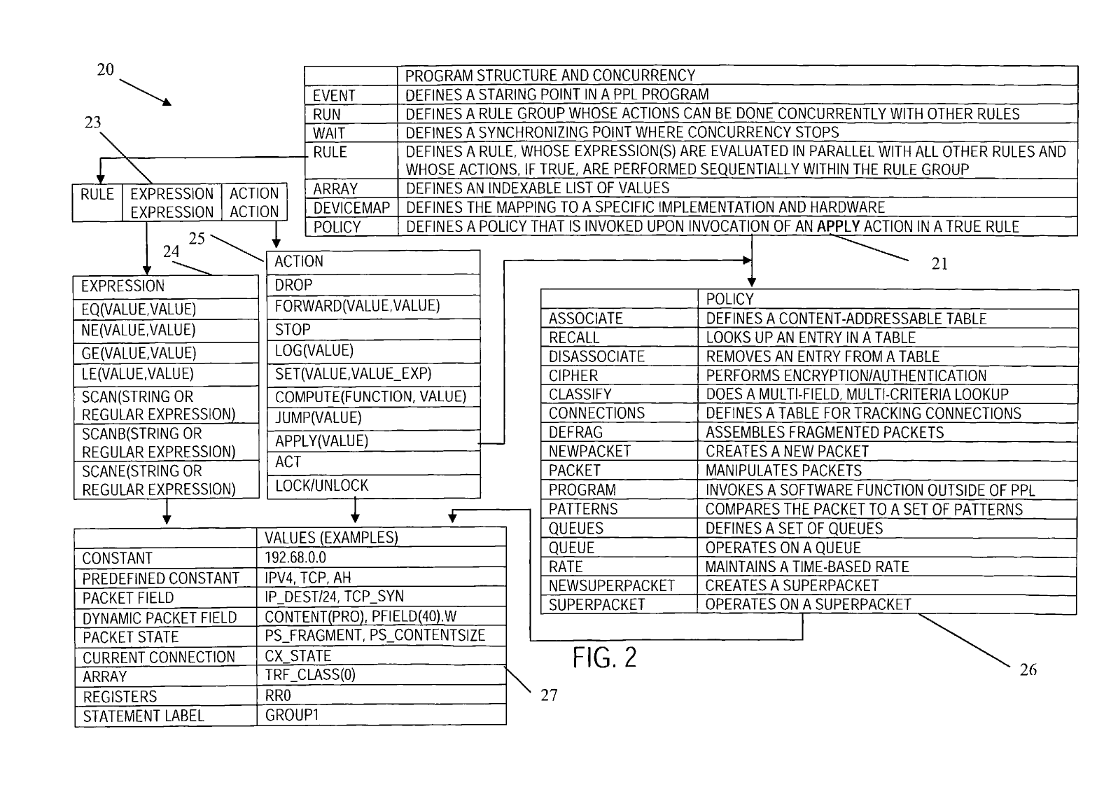

FIG. 2 shows the PPL 20 as a structure 22 comprising a high-level language including rules 23, events 21 and policies 26 for describing the processing of network packets adapted for implementation on a network processor 100, such as, but not limited to, the Intel 1XP2xxx family of NPUs, in accordance with an embodiment of the present invention. Rules 23 and policies 26 are two statement types in the PPL 20. Rules 23 comprise expressions 24 and actions 25 adapted to make decisions and apply policies 26. Rule expressions 24 are evaluated and the actions of true rules are executed sequentially and/or in concurrent groups. Actions 25 represent simple actions or the invocation of policies 26.

A PPL policy 26 is a major function, such as, but not limited to, keep track of a specific flow connection (e.g., TCP connection, SIP session), encrypt a packet's payload, add or strip a header to a packet, create a new packet, manage a set of packet queues, search a packet against a large database of signatures, and send a packet to another PPL program, a control-plane program, or a program in an attached processor.

PPL is more of a functional language than a procedural language. PPL has no fixed concept of single-threaded, sequential execution, which is a concept of procedural languages. While completely abstracting away any parallelism in the underlying processor, PPL provides a plurality of concepts of natural concurrency, one being that the arrival of a packet creates a parallel instance of the PPL program.

PPL is architecture independent. PPL completely hides the details and nature of the underlying processor. As such, it provides scalability because the same PPL program will run on a different model of the same NPU family. It also provides the opportunity of portability to completely different NPU types.

In accordance with an embodiment of the present invention, the implementation of PPL is not just a language, but a complete subsystem. In an embodiment, the virtual machine implementation on Intel's IXP network processor family doesn't just process the packet processing language, it also contains such pre-built functions as Ethernet transmitters and receivers, default IP forwarding, and Linux-based control-processor support, allowing one to install the product, write a PPL program, and run it on live networking hardware relatively quickly and easily.

Referring again to FIG. 2, the PPL 20 comprises rules 23, events 21, and policies 26. By way of example and to facilitate explanation, the following discussion provides example expressions 24 for rules 23 and policies 26. A rule 23 lists one or more conditions under which a set of specified actions 25 are performed. For example, the following rule 23 says that if the current packet is an ESP IPSec packet, then policy in_ipsec should be applied:
Rule EQ (IP_PROT, ESP) APPLY (in_ipsec)

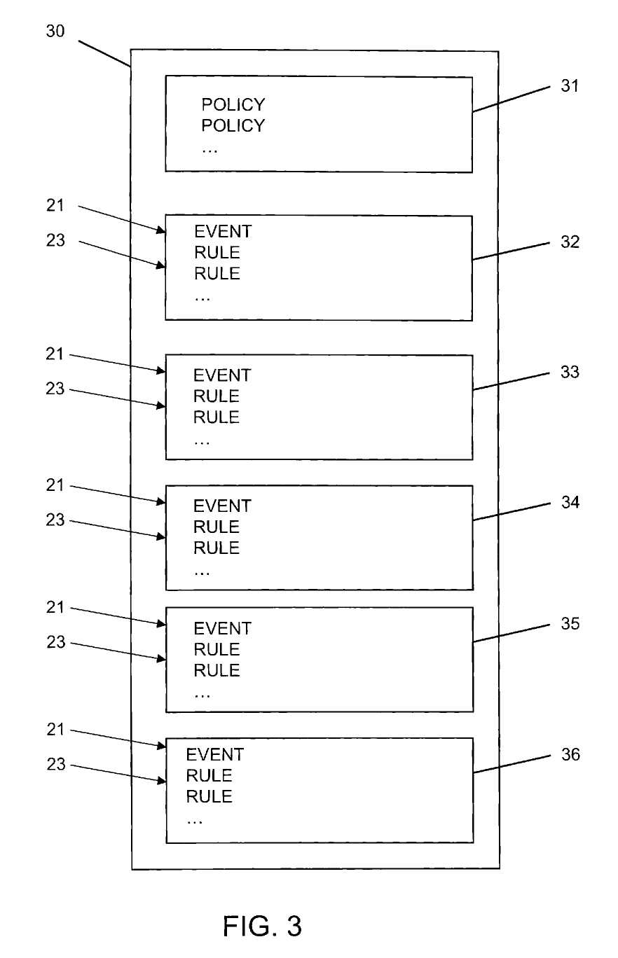

An event 21 is a set of rules 23 that are processed when triggered, as shown in FIG. 3. An example of a trigger is the arrival of a packet, although events can also be triggered, such as, but not limited to, by timer and from a program or processor outside of PPL. For example, the following event applies to logical ports 1 and 2. It applies a policy if the packet is a TCP packet with just the TCP SYN flag set, and then it unconditionally forwards each packet:

Event (1,2)
Rule EQ (TCP_SYNONLY,1) APPLY (tcpconnrate)
Rule FORWARD STOP

Note that there could be many instances of this event running concurrently if at any instant in time there are multiple packets available from these two ports.

FIG. 3 illustrates multiple events 21 each having multiple rules 23 executed within the PPL Program 30 on multiple processors 32-36, in accordance with an embodiment of the present invention. All rules 23 are evaluated concurrently. The actions of true rules in an event are processed sequentially. Events are processed concurrently, that is, rules in separate events are processed concurrently. Multiple instances of the same event are also processed concurrently.

A policy 26 is a function which can have an internal state. For example, consider the following policy:

```
Enc: Policy CIPHER ENCRYPT (AES, SHA1)
    KEY (keystore(n)) LOCATION (CONTENT, 0)
    PAD (SEQ)
```

The above policy does the following when applied: the payload of the current packet is encrypted in place using the AES 128 cipher with a key from the array keystore. Sequentially numbered padding values are added as needed. The ciphertext is also accumulated in a hash digest using the SHA-1 algorithm.

Referring again to FIG. 2, the PPL 20 also comprises values 27. Values 27 in PPL 20 are packet centric. There are several ways to refer to data in and about a packet: named packet fields, dynamic packet fields, and packet states, among others. Named packet fields refer to such things as IP addresses. PPL can be used with any protocol, in particular with IPv4, IPv6, TCP, UDP, among others. IP_DEST refers to the destination IP address in the current packet. PPL also understands dynamically the difference between IPv4 and IPv6, so the rule:
Rule EQ(IP_SOLRCE,IP_DEST) . . .
behaves as expected whether the current packet is IPv4 or IPv6.

Dynamic packet fields refer to the ability to index explicitly to data within a packet. For example, PFIELD(2).b refers to the byte at offset 2 in the current packet. CONTENT(n).q refers to the quadword (16 bytes) beginning at offset n within the packet payload.

Packet state refers to static information about the current packet. PPL defines a number of values that represent static information about the current packet. For instance PS_FRAGMENT is a Boolean indicating whether the current packet is a fragment (meaning either bit MF set or non-zero fragment offset present in an IPv4 packet, or presence of a fragment extension header in IPv6). PS_LPN is the logical port on which the packet arrived. PS_VLAN is the virtual network to which the packet belongs.

Constants are also packet centric. For example, the following rule:

Rule EQ(IP_DEST/24,66.197.248.0)
NE(IP_PROT,UDP) . . .

determines if the first 24 bits of field IP_DEST in the current packet are equal to 66.197.248 and if the IP protocol field is not UDP.

Many policies manage data structures that aren't directly visible to the PPL user. For example, the CONNECTIONS policy manages a connection table, and QUEUE policy manages a packet queue, and the ASSOCIATE policy manages an associative lookup table. An array is one data structure that is available to the PPL user. For example:
Alternate_servers: ARRAY(32).q
defines an array of 32 quadword (16-byte) values. Although the PPL virtual machine can determine where the array will actually reside, an implementation dependent part of PPL allows one to control, when needed, the actual mapping of an array. Also, since the virtual machine always knows the extent of an array, it will never allow the programmer to refer to a nonexistent element.

A register is a temporary “variable” adapted for performing simple computations and for input values to policies. In an embodiment of the PPL, the PPL defines several types of conceptual registers, not to be confused with hardware registers. Each occurrence of an event has 32 registers, and the PPL as a whole has 256 global registers. A single register is a 32 bit value, and four consecutive registers can always be used as a 128-bit value. The registers may be mapped by the virtual machine into fast memory (e.g., actual hardware registers).

PPL thus comprises rules packaged into events, and rules refer to policies, as shown schematically in FIG. 3. There is a special event that will be invoked by the virtual machine in the event of an exception, and another special event that will be invoked at system startup.

By way of example and to facilitate explanation, the following discusses the implementation of PPL on the Intel IXP28xx NPU's, in accordance with an embodiment of the present invention. Although PPL could theoretically be compiled to a machine instruction set, the embodiment of the implementation on the Intel IXP28xx compiles PPL to a low-level representation which is then interpreted by the virtual machine. Much of the design of the virtual machine is aimed at extracting the full power of the NPU's resources for optimal performance. The virtual machine is designed very much like one would design a high-end CPU, meaning it is pipelined, uses many concurrent execution units, does asynchronous (overlapped with execution) memory operations, and has received careful cycle-by-cycle optimization, for example.

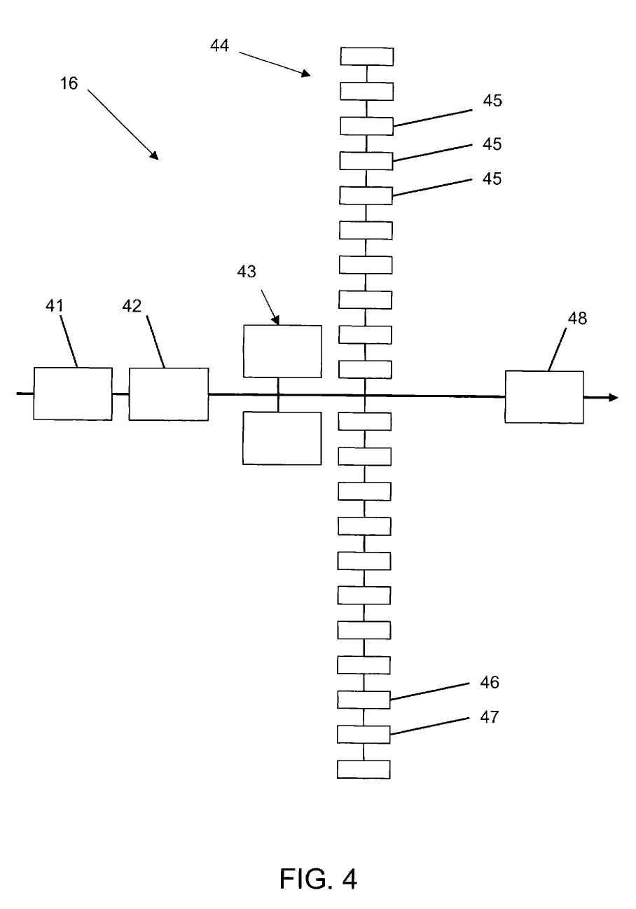

FIG. 4 is a schematic of the PPL Virtual Machine pipeline 40, in accordance with an embodiment of the present invention. The virtual machine is adapted to interpret functional logic using parallel programming optimizations. Besides receive 41 and transmit 48t, there are three stages in the pipeline 40:

Connection Engine (CE) 42 performs lookups of state and event information;

Broad Evaluator (BE) 43 identifyies a specific range of rules to be executed based on the event value passed in by the CE stage. This stage also does a certain amount of “pre-qualification” on the rules within the event in an attempt to further reduce the number of true rules to be executed on the packet;

Action Engines (AE) 44 evaluate expressions and performs actions for the event based on the list of true rules provided it by the BE.

Packet flow starts with the receiver 41 and moves progressively to the right, with a packet ultimately being dropped, transmitted, passed to an XScale or queued on another event for later processing. Scratch ring interfaces (not shown) pass packets and control messages between the PPL virtual machine and XScale core software.

The processing of PPL events is done by the virtual machine's action engines (AE) 44. An AE 44 is presented with an arrived packet and the PPL event to run on behalf of that packet. The IXP28xx has 16 independent microengines 45, also referred to as processors, and each has 8 hardware-switched threads. The virtual machine 16 allocates most of the microengines 45 to AE's 44, and allocates two AE's 44 per microengine 45. Two is a good tradeoff given resource constraints, because when a microengine 45 is stalled as a result of an AE 44 doing a memory read or write, the other AE 44 on the microengine 45 runs. In an embodiment, 24 AE's 44 get allocated on 12 microengines, so 24 PPL events get processed in parallel. At the other extreme, 24 occurrences of one PPL can be run.

PPL execution is also pipelined to a certain degree, which is the role of the connection engine (CE) 42 and broad evaluator (BE) 43. The CE 42 does certain preprocessing on each packet, such as looking up its connection state (if the CONNECTIONS policy is being used). The BE 43 evaluates any rule expressions that can be evaluated safely ahead of execution (e.g., those that refer to packet state or contents). Thus the BE 43 can often “rule out” some of the rules of the PPL event to be run on an AE 44.

Most policies, when applied, run directly on the AE 44 of the event invoking the policy, but a few policies have such a large internal state that they need a separate microengine 45, referred to as a policy engine (PE) 46, when used. In other embodiments, separate microengines 45 are allocated to a crypto unit 47.

With the PPL virtual machine 16, processing power is dynamically assigned, in accordance with an embodiment of the present invention. In a conventional IXP2xxx software design, one assigns a fixed role by programming it to each microengine, and the microengines operate in pipelined fashion to process a packet. Thus the allocation of processing power is predetermined by the software designer, cannot be dynamically changed, and thus at virtually any instant in time is suboptimal. In the PPL virtual machine 16, processors move from program to program (event to event) as the need arises. There is provided a way to ensure that packets from the same flow are processed sequentially so that they do not get out of order. Also, if there is a PPL event that must be processed serially, there is provided a way to designate such.

By way of example and to facilitate explanation, the following discusses mapping the PPL virtual machine onto an Intel IXP2350, which has four microengines, in accordance with an embodiment of the present invention. Because the IXP2350 has a larger local memory per microengine than the IXP28xx, three AEs can be allocated per microengine. Therefore, in the IXP2350 configuration, there are six AE's allocated in two microengines, a combined CE/BE take a third microengine, and the fourth microengine runs the receiving and transmitting threads and some incidentals, including a PE function if needed.

Rules can do one or more equality and magnitude comparisons on pairs of values, optionally with masking, as in the use of the subnet mask in the example earlier. Anther expression is SCAN, which provides payload scanning. For example, the following will search the current packet for the designated string, which happens to be a signature for the subseven Trojan horse:
Rule SCAN (“|0D0A5B52504C5D3030320D0A|”)

Regular expressions can be used with SCAN. For example, suppose we wish to examine the payload of each packet going to TCP port 80 to see if it is a GET HTTP transaction with a URL ending with redirect.html and containing a session cookie. The PPL rule would be:

```
Rule SCAN (re“GET.*?redirect.html
        \s.*?HTTP/l.*?Cookie:”,0,0)
    EQ (IP_PROT,TCP) EQ (L4_DPORT,80) . . .
```

Rules can contain one to many actions, which are performed sequentially if the rule evaluates to true. One example of an action is APPLY(x)—where x is the name or value of a policy. Policy names have values, which means that policies can be selected dynamically by computing a value. Other actions include SET, FORWARD, DROP, LOCK and UNLOCK, and COMPUTE, among others. SET computes the value of a simple, one operator, expression and assigns the value. SET is adapted to operate on 32- or 128-bit values or a combination of the two. FORWARD transmits the current packet to a location. The location depends on the values expressed with the action. DROP drops the current packet. LOCK and UNLOCK manipulate a specified lock and are useful when concurrent events need to update a shared array, for example. COMPUTE performs a more-complex function on one or two values. Examples of the functions that can be expressed are converting a character IPv6 address to binary, converting endian representation, hashing, get random number, get current time, compute a checksum, and compute a CRC, among others.

Presented is an example that would entail a large number of statements in a language such as C but is a single rule in PPL. We are processing some layer-7 protocol that embeds IP addresses in character form. We wish to search for something that appears to be an IPv6 address in the packet payload and convert it to a binary IPv6 address. It accounts for the IPv6 “::” zero-compression notation and leaves a 128-bit binary IPv6 address in Rr0q. It uses a form of SCAN (SCANB) that returns the offset of the match, if found:

```
Define nums = “[0-9A-F] {1,4}?”
Rule SCANB (reul“ (nums : ) {7,7} ?nums | nums
        ( : nums) {0, 6} ? : : | : : (nums : )
        {0,6} ?nums | nums ( : nums)
        {0,5} ? : : (nums:){0,5}?nums ”)
    NE( (Rr0,FuF)) COMPUTE (CBIP,Rr0q,Rr0)
```

PPL programming consists of rules that make some decisions and perform some actions, but policies are where most of the logic is embedded. Policies include: CIPHER, ASSOCIATE, PACKET, NEWPACKET, DEFRAG, SUPERPACKET, PROGRAM, CONNECTIONS, PATTERNS, RATE, QUEUE, CONTROL, MONITOR and CLASSIFY, among others. CIPHER allows one to encrypt and decrypt part or all of the current packet in a manner that is not tied to any specific protocol (e.g., IPSec, SSL, TLS, 3GPP, RTP encryption, XML encryption). Options exist for different algorithms, whether to cipher in place or not, and for different types of padding. It also allows one to accumulate data into a hash digest and calculate an HMAC.

ASSOCIATE and a few related policies create and manage a content-addressable data structure such that one can look up values by search keys. It has a wide range of uses, such as looking up IPSec security policies, doing NAT, maintaining flowbased traffic counts, and others.

PACKET performs certain functions on the current packet or a different packet for which one possesses a handle, such as dropping it, making it the current packet, and inserting or stripping header or trailer space at different places within the packet.

NEWPACKET creates a new packet, with options relating to its initial value, whether it encapsulates the current packet, among others.

DEFRAG collects packets deemed to be related fragments until all the fragments have been collected or a reassembly time is exceeded.

SUPERPACKET manages and operates on a “superpacket,” which is an arbitrary ordered set of whole packets whose collective payload one wants to treat as a single payload. Superpackets are especially useful in detecting signatures that span multiple IP packets.

PROGRAM is a policy that allows a PPL program to communicate with a program outside of the PPL virtual machine.

CONNECTIONS provides the means to track multidirectional flows of related packets, such as those of a TCP connection, The virtual machine builds a connections table for each instance of the CONNECTIONS policy; connections can be created by applying the policy and are automatically looked up by the CE engine discussed earlier. Numerous options exist, such as qualifying a connection by virtual network (e.g., VLAN), using two sets of IP and port addresses to support NA T, and keeping a timebased set of state transitions.

PATTERNS has several different manifestations. One does a multi-pattern search of the packet (or superpacket) content against a database. In the IXP2xxx implementation, a further-optimized form of the WuManber algorithm is used; the algorithm can determine that the payload doesn't match a database of 1000s-100,000s of patterns in a remarkably short time. The second form compares a value (such as an IP address) to a database, looking for the longest-prefix match. In the IXP2xxx implementation, a further-optimized Eatherton tree-bitmap algorithm is used.

RATE maintains time-based rates (e.g., rates of occurrences, bit rates). In the example below, we use it to inhibit more than 1000 TCP connection attempts per 30 seconds over a time period of a day:

| Define day = “86400000” #Msec per day | |
|---|---|
| Define sec30 = “30000” | |
| Con_rate: Policy | RATE |
| | RESETTIME(day) |
| | TIMEBASE(sec30) |
| | COUNTING(1) |

. . .
Rule EQ(TCP_SYNONLY,1) APPLY (Con_rate)
GE(Rr0,1000) LOG DROP

Many policies return a value in Rr0. LOG and DROP are two additional actions. And this is written correctly as a single rule.

QUEUE defines a set of packet queues and performs an operation on a queue, namely enqueue, dequeue, and query. Options exist to weight the queues and provide for optional triggering of a PPL event when a queue becomes non-empty. Another option is whether active management of the queues should be done. If active management is selected, a variety of modes exist to select how automatic dequeues are done and what is done with the dequeued packets.

CONTROL is a policy whose definition allows for easy extension of control functions. One function is defined as enabling or disabling the processing of a specific event on a periodic (timed) basis.

MONITOR defines how packets are monitored.

CLASSIFY is a general multi-field, multi-criteria searching mechanism to look up a set of values in a database. An implementation-dependent provision exists to map the database into a TCAM. CLASSIFY is useful in comparing a set of values, such as a 5- or 6-tuple from the current packet, where the comparisons aren't exact matches or where the comparison operators are different for each item in the database.

The PPL is adapted to interact with a variety of non-PPL programs, in accordance with an embodiment of the present invention. The PPL program can forward a packet to an outside program or invoke an outside program via the PROGRAM policy, and vice versa. Other than PPL-to-PPL, the means become implementation dependent at some level. By way of example and to facilitate explanation, the following discusses the implementation on the Intel IXP2xxx NPU. When the PPL program is the initiator, the FORWARD action is linked to a network port or to an external program to send a packet and the PROGRAM policy is linked to an external program to do a “remote procedure call” with parameters. A protocol called PXD exists where the other processor is connected over a PCI or PCI Express bus.

In the opposite direction, using PXD, software in an attached processor such as a Pentium, for example, can send a packet to a PPL event and invoke a PPL event with parameters.

The PPL program can also interact with data-plane microcode, such as by using Intel IXP terminology, for example, microcode that a user might need. In this case, applying the PROGRAM policy causes an entry to be placed on a ring upon which the microcode is waiting, or to generate a microthread signal. The microcode can easily send a packet to a PPL event.

The PPL program can also communicate with another PPL program in a different NPU.

Although PPL programming is independent of a particular processor model or architecture and particular board or blade design, there are relationships that need to be defined for handling hardware dependencies. This is done via the PPL DeviceMap statement which isolates the physical and implementation dependencies to one spot in the PPL program. DeviceMap is NPU specific and a separate specification will exist for each NPU type. The specification of the Device Map for the IXP2000 family of network processors can be found at www.IPFabrics.com, entitled PPL IXP2000-Family Device Map, dated Jan. 25, 2005, which is hereby incorporated herein by reference for all purposes.

By way of example and to facilitate explanation, the following discusses the implementation using the IXP2xxx DeviceMap:

```
DeviceMap
    NPU (2350,900,21)
    PACKET_MEM (DRAM,16392,20,64)
    ARRAY_MAP (serv_list,ext_$$pdkservlist)
    LINK (0,INOUT, GE_INT, 0)
        LINK(1,INOUT,GE_ON_SPI,0,8,1514,0,0,0,0, “IXF1104”)
    LINK (2,OUT,PCI)
    PROG (lin_stk_dr, REMOTE)
    PROG (3,CONTROL,ext stk_dr)
```

The above provides:
The NPU is an IXP2350 with a microengine clock speed of 900 MHz, and of the many modes the IXP2350 supports, this one is configured with one internal gigabit Ethernet MAC enabled and MSF channel 0 as a 16-bit SPI-3 SPHY interface (mode 21).
Allow 16 MB of DRAM for packet buffers, leave at least 20 bytes of space in front of every packet and use 64 bytes of metadata per packet.
There is a specific PPL array serv_list that we want located in memory at the same place as symbol ext_$$pdkservlist in the XScale processor.
PPL logical port 0 maps to the internal gigabit Ethernet controller 0.
PPL logical port 1 maps to a port in an IXF1104 Ethernet controller on MSF channel 0. The other values are some Ethernet controls.
PPL logical port 2 maps as an output to the PXD mechanism over the PCI Express bus.
A PPL PROGRAM policy that refers to the symbol lin_stk_dr causes, when applied, an interprogram communication to a program of that name on a host processor on the PCI Express bus.
PPL logical port 3 maps as an output to a packet being sent to program ext_stk_dr on the XScale control processor.

The DeviceMap section of PPL is adapted to provide a number of other capabilities, such as, but not limited to: controlling what memory the PPL virtual machine does and doesn't use; suggesting, on a percentage basis, how microengine resources are allocated to different functions (e.g., AE's, BE's, receivers, . . . ); similar LINKs for POS and fabric interfaces; automatic tests for malformed packets; and debug controls.

Because of its power of expression and its run-time checking, networking functions written in PPL have less exposure to latent system hang-ups and undiscovered security holes. Event 998 is defined to be an exception handling event. When an exception occurs, that PPL event is invoked, along with the type of exception, the rule causing the exception, and the current-packet handle. Types of exceptions include extent errors (e.g., relative to a packet or array), invalid packet handle, insufficient storage, lock timeout exceeded, among others.

Although PPL is IP specific, the language definition can be adapted to support ATM AAL2 and AAL5, among others.

The language definition provides for a level of concurrency smaller than an event, referred to as a run group. Referring again to FIGS. 2 and 3, groups of rules, including rules applying policies, can be designated as run groups, meaning that they can be processed concurrently with any other run group in the event.

Because of its virtual-machine implementation, it is possible to do dynamic compilation, where the PPL program is changed while running.

Also, in other embodiments, the PPL is compiled directly to a machine instruction interface.

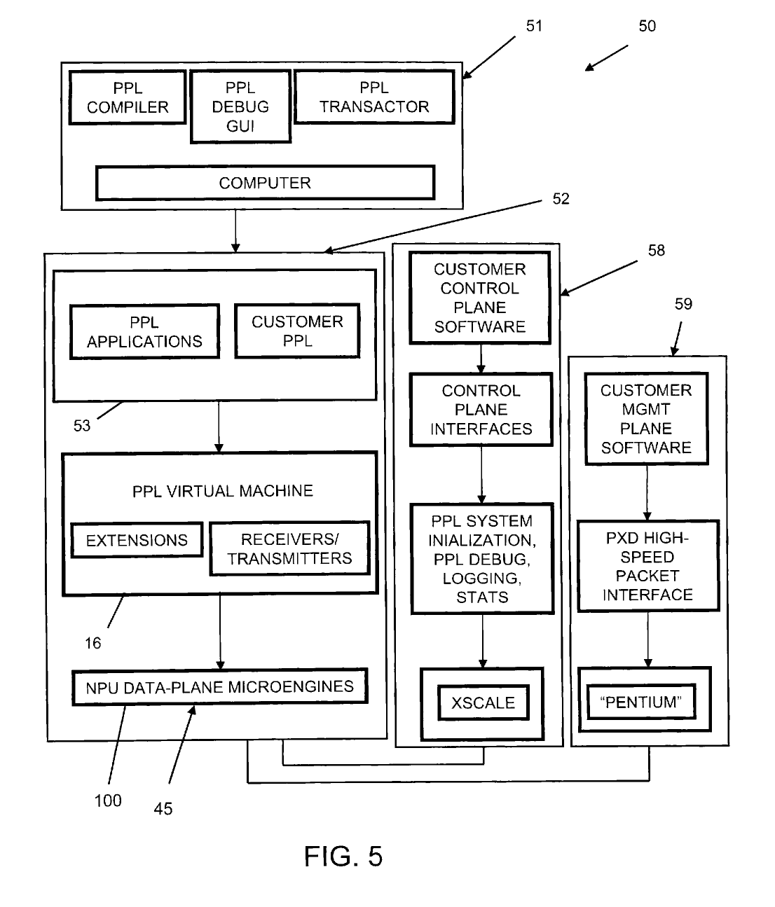

FIG. 5 illustrates a system-level solution 50 from the creation and compilation of the PPL bytecode on a computer 51 to the implementation of the PPL bytecode 53 on the PPL virtual machine 16 controlling the NPU 100, as associated with XScale 58 and CPU 59 type processors, in accordance with an embodiment of the present invention. The utilization of the PPL programming 53 and virtual machine 16 for programming network processor(s) 100 presents a number of advantages and disadvantages in terms of performance in both programming and implementation. The PPL/virtual machine system provides a programming solution that speeds program development wherein the programmer does not need to have expertise in the many details and aspects of the NPU architecture. Contrasting with NPU programming for the same application in microengine assembly language written by engineers having substantial expertise in the many details and aspects of a specific NPU architecture over a substantial period of time, the resulting performance penalty using a PPL program for the Intel IXP2xxx family has an approximately 20-30% performance disadvantage, in accordance with some testing. A middle ground is using the C language, but this approach still requires considerable NPU expertise by the C programmer, and the resultant C code is highly NPU-model-dependent and thus not portable. Generally, PPL should perform as well or better than NPU C programs written by engineers not having substantial expertise in the many details and aspects of the NPU architecture.

There are situations where PPL has no penalty and in fact is faster. One is related to dynamic processor assignment. Using the conventional approach the function of each microengine is fixed. For example, if there are both ingress and egress paths, some microengines are pipelined in the ingress path and some for egress. At any instant in time, it is unlikely that all microengines have work to do. In fact, if at an instant in time, the ingress traffic is heavy but the egress traffic is light, half of the NPU is going to waste and perhaps packets in the heavy ingress load are dropped. In PPL, events get dynamically assigned to a processor short-term as their stimuli, usually a packet, arrive.

Another way that PPL programs can actually be faster than the alternatives is when the PPL program spends most of its time in policies. Policies are major functions that have been carefully written and optimized by NPU experts for maximum performance.

Many believe that the best answer to performance optimization is to have a running system as early in the product cycle as possible in order to have the maximum amount of time to study it and optimize it in real-life situations. The PPL provides the means to program NPUs relatively quickly so as to address this performance benefit. PPL has proven itself to be a highly effective language for the development of NPU data-plane software. In conventional approaches, because of the high complexity of NPU architectures, the software developer typically spends 90% of his or her time on the many details of the NPU and its tools, and very little time thinking about the application itself. With PPL, the tables are reversed; the focus of the software developer is on the application, and the total time from starting to having a working system on live hardware literally goes from multiples of months or years to a few days.

Performance of a programmable network device is characterized by throughput, latency and footprint. In addition to being far easier to develop, code written in PPL and interpreted by the PPL Virtual Machine can outperform code written in a low-level language, for may applications. This is accomplished by hiding memory access latency, performing data-path optimization reducing communication between threads and enforcing functional re-use. These optimizations scale very well with logic complexity and far outweigh the virtual machine overhead.

Network device performance is typically characterized by three parameters—Latency, Throughput and Footprint. Latency (measured in seconds) is defined as the time-interval between departure and arrival of frames on the output and input ports respectively. Throughput (measured as frames per second) is defined as the maximum rate at which none of the received frames are dropped. The frame size is system or application dependent. For example, very short frames may not make sense for video-over-IP applications.

Footprint is an important parameter because it translates to the device cost to meet throughput and latency objectives. It is important in the virtual machine context as well, because it provides an interesting metric to judge the quality of virtual machine implementation for a target machine. Footprint is measured by the instruction and data space (percentage of capacity) needed in heterogeneous storage elements.

PPL programs 53 are written and compiled for the virtual machine 16. At runtime, this application logic is interpreted by the virtual machine 16 to run on the target network processor 100. The target network processor 100 can have many RISC-type processors or microengines 45 with specialized instruction-set architecture, software-managed interconnect, limited instruction space and heterogeneous storage elements. The virtual machine 16 uses parallel programming optimizations, to minimize the runtime penalty.

The virtual machine can simultaneously receive new packets from network ports or a switch fabric, doing state lookup on one or more earlier packets, evaluating rules for an additional set of packets, processing true rules on one or more packets, doing next-hop lookups on another set of packets, and transmitting yet another set, among others.

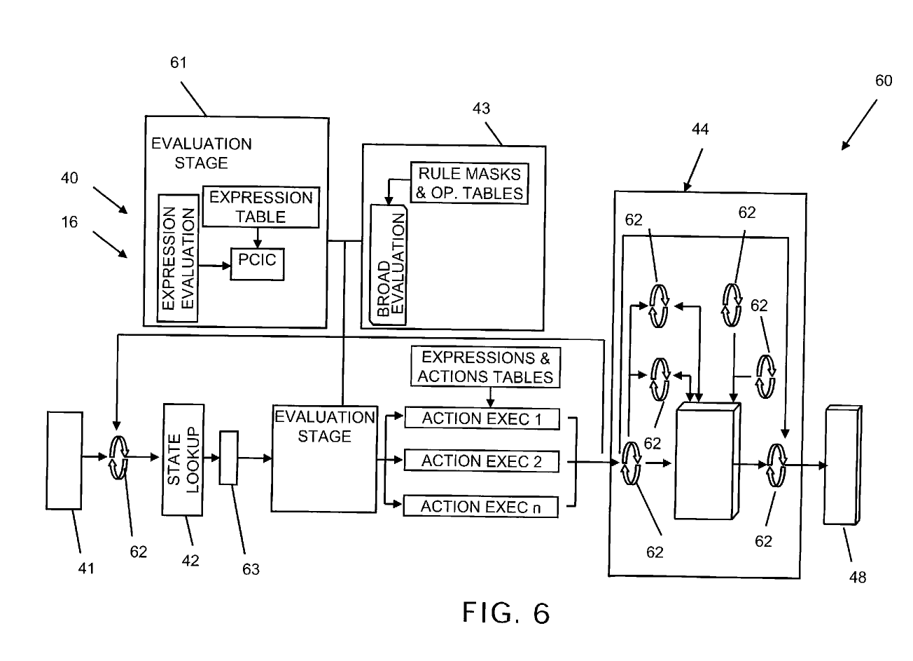

FIG. 6 illustrates the PPL virtual machine architecture 60 including packet flows, components, and component interfaces, in accordance with an embodiment of the present invention.

Memory access latency: Scratch ring 62 trips are more expensive than general-purpose or next-neighbor register 63 trips, SRAM trips are more expensive than scratch ring trips and DRAM trips are more expensive than SRAM trips. The virtual machine 16 spreads these storage element accesses to maximize microengine and Xscale utilization, and also organizes the movement of data between heterogeneous storage elements, to reduce latencies.

Data-path optimization: PPL provides a rich set of highly optimized network processing primitives written in microcode, including Patterns, Connections, Monitor, Associate, Packet, Crypto, Rate, among others. These primitives are referred to as policies in PPL. Policies are used to perform complex modifications to packets selected for processing by the PPL program. The virtual machine has basic logic primitives as well, but these are generally used in wrapper logic around the core primitives. Also, the language syntax and virtual machine implementation allows user specified “custom” microcode or off-loaded remote logic, for example, DSP on the PCI bus, to inter-work with PPL code.

Communication between threads: Communication between threads of the same microengine, different microengines of the same cluster, or even different clusters have varying degrees of negative impact on the overall throughput and latency. To reduce this impact, specific strategies are adopted while mapping the various stages of the virtual machine pipeline to microengine threads. For example, to optimize memory utilization in the virtual machine pipeline, all the “broad evaluator” threads are co-located, BE and CE threads have next-neighbor register adjacency and AE (early and late processing) threads are co-located in the same microengine, in accordance with an embodiment of the present invention.

Functional re-use: In a PPL program, one can associate a particular type of policy, for example, Associate and Connections, with multiple rules. This type of re-use helps keep the footprint or virtual machine overhead low. Only 25% of the footprint, that is the instruction memory portion is non-policy related, and this number will shrink further as new policies are added, and BE and/or CE is further optimized.

For smaller applications, one could easily apply these time tested parallel programming techniques and write programs in a low-level procedural language. But as complexity grows, this becomes a challenge. In IXP28x0, there are 15,452 software visible registers to manage, besides the numerous accelerators and heterogeneous storage elements.

PPL virtual machine 16 automates this process; logic specified in PPL is compiled to bytecode, which includes the expression/action, policy-descriptor, array-descriptor and other user-defined tables. At runtime, in a continuous loop, events, such as the arrival of packets on ports, direct Action Engine (AE) 44 computations that are driven by these tables. The CE 42 and BE 43 precede AE 44 and can be considered as the only fixed overhead for the virtual machine implementation, since Rx 41 and Tx 48 stages are intrinsic to any implementation.

Applications with dense AE computation, like in edge-network elements for example, benefit from the virtual machine approach, since the CE and BE overhead is easily masked.

Besides keeping the instruction memory footprint due to CE and BE stages low, other measures with varying degrees of payoff can be adopted to limit the virtual machine overhead, such as but not limited to: by minimizing the wrapper logic (e.g. set, and, or, scan, Ishift, etc.), and instead taking advantage of policies, such as patterns, connections, association, crypto, among others, computation latency can be improved, because policies are highly optimized microcode; by configuring virtual machine parameters in device-map, such as array-memory, association-memory, among others, to reduce lookup time, such as, SRAM as opposed to DRAM, overall latency is reduced; by sequencing the rule-elements based on traffic-analysis (e.g. putting expressions that evaluate to false mostly ahead of others), overall throughput and latency objectives can be improved; and by appropriately distributing expression evaluation in the PPL program to early and deferred AE processing phases of the virtual machine, such as using act to break the rule-element chain, throughput through the virtual machine can be improved. This allows computations for two separate packets to be interleaved.

PPL and its implementation on Intel's IXP network processors have proven to be an effective way to develop NPU software without investing significant cost in NPU expertise, yielding substantial gains in time to market, good performance, and better product robustness, in accordance with an embodiment of the present invention.

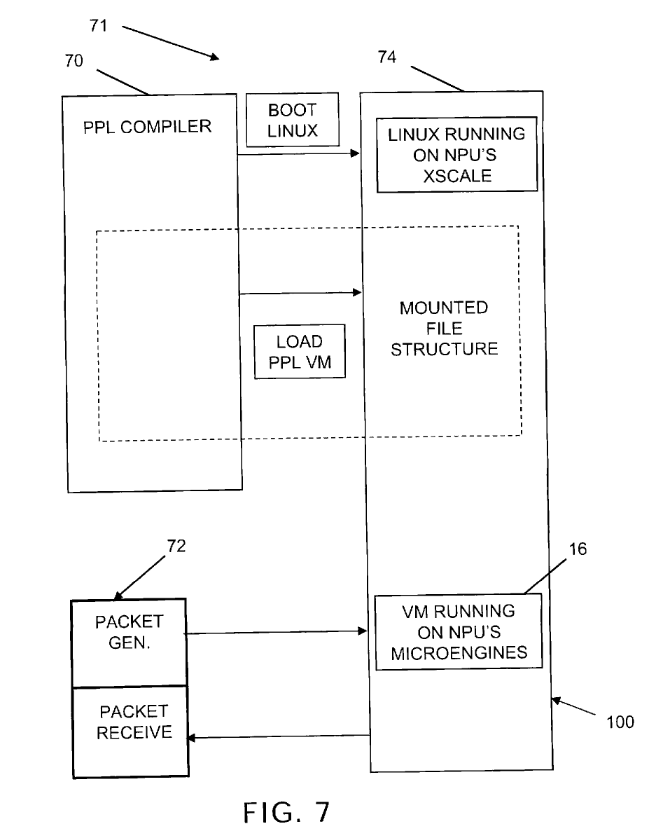

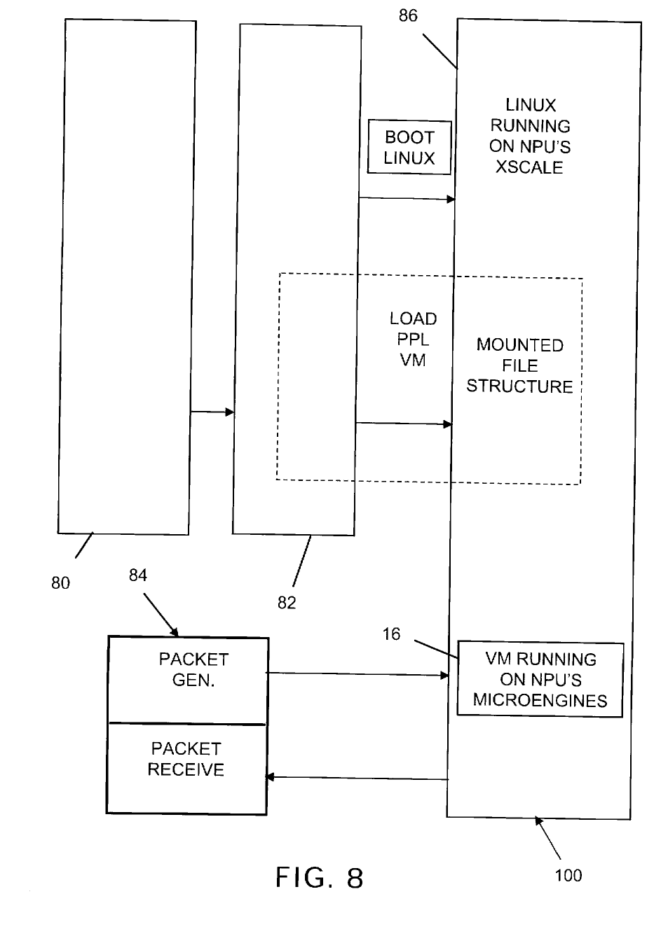

FIGS. 7 and 8 are two embodiments of methods for writing and compiling PPL programs, in accordance with the present invention. In FIG. 7, a Linux version 80 of the PPL compiler 70 is hosted on the same Linux host 71 containing the NPU boot server and file system 74. In this method, the PPL programs are created and compiled in the same file system used by the NPU. In FIG. 8, either the Linux or Microsoft Windows version of the PPL compiler is hosted on separate, network-attached computers 80, 82. In this method, the PPL program is written and compiled on the separate computer 80, 82 and the necessary files are copied to the Linux host 86 containing the NPU boot server and file system.

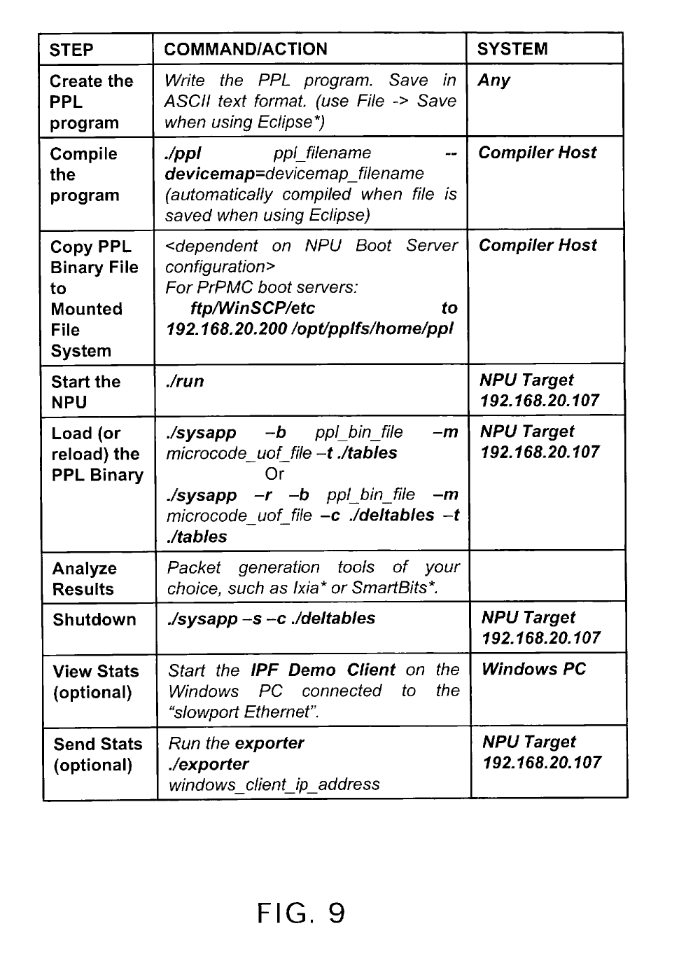

FIG. 9 is a table containing a summary of the steps, the appropriate commands/actions within those steps and the systems on which the steps are executed, in accordance with an embodiment of the present invention.

Referring again to FIG. 6 which is a schematic diagram of a PPL virtual machine architecture 60 including packet flows, components, and component interfaces, including a portion of the virtual machine 16 implemented in hardware 61, such as, but not limited to a Packet Content Inspection Co-Processor (PCIC). The hardware 61 reduces the number of expressions and actions that the virtual machine needs to evaluate. This reduction greatly improves performance of the virtual machine and underlying NPU operation. By way of example, in a PPL program with 100 rules, the hardware 61 is used to sort out and select a subset of the rules, leaving a relatively few number of rules to be executed by the BE 43 of the virtual machine 16.

The hardware 61, also referred to as a PPL accelerator, allows part of the PPL virtual machine 16 to be implemented in hardware. This hardware implementation speeds up the processing of the PPL bytecodes. In particular, the translation of the PPL bytecodes into network processor instructions is at least partially done in the hardware 61. The hardware 61 converts PPL bytecodes into network processor instructions, which are supplied to the NPU 100.

The hardware 61 can be incorporated into a NPU 100 or as an external component.

In accordance with embodiments of the present invention, small amounts of critical functions in many applications benefit by bypassing the virtual machine and being directly implemented on the hardware. The virtual machine provides the means to interface with user-written directly coded algorithms.

In accordance with an embodiment of the present invention, nth degree optimization of memory accesses is implemented in the virtual machine. This implementation improves processor performance. Again using the IXP2800 as an example, the average read time from memory is 150 to 300 cycles, depending on memory type, congestion, among others, but the instruction execution time is one cycle. So the system can execute, on just one of the processors, several hundred cycles in the time it takes to do one memory read. One consequence is that performance becomes largely a function of how much data is moved between processor and memory per packet.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A packet processor for processing packet data, comprising:
a network processing unit; and
a virtual machine associated with the network processing unit, the virtual machine adapted to interpret packet processing bytecode into binary code readable by the network processing unit.

2. The packet processor of claim 1, wherein the network processing unit comprises a plurality of parallel processors, the virtual machine adapted for the parallel processing of packet processing bytecode enabling the network processing unit to parallel process the packet data.

3. The packet processor of claim 2, wherein the packet processing bytecode comprises:
policies comprising one or more packet processing functions;
rules comprising one or more expressions and actions adapted to apply the policies; and
events comprising one or more rules.

4. The packet processor of claim 3, wherein the virtual machine is adapted such that a plurality of rules are executed concurrently across a plurality of parallel processors of the network processing unit.

5. The packet processor of claim 4, wherein the virtual machine is adapted such that the events are dynamically assigned to respective processors.

6. The packet processor of claim 5, wherein the virtual machine is adapted such that the actions of true rules in an event are processed sequentially.

7. The packet processor of claim 5, wherein the virtual machine is adapted such that multiple instances of the same event are processed concurrently.

8. The packet processor of claim 5, further comprising:
a hardware accelerator associated with the virtual machine, the hardware accelerator adapted to implement at least part of a virtual machine.

9. The packet processor of claim 8, wherein the hardware accelerator comprises a packet content inspection co-processor adapted to reduce the number of rules.

10. The packet processor of claim 8, wherein the hardware accelerator is external of the network processing unit.

11. A method using pipelined and superscalar parallelism for a packet processing virtual machine, comprising:
providing a virtual machine adapted for association with a network processing unit, the virtual machine adapted to interpret packet processing bytecode into binary code readable by the network processing unit, wherein the packet processing bytecode comprises:
policies comprising one or more packet processing functions;
rules comprising one or more expressions and actions adapted to apply the policies; and
events comprising one or more rules; and
executing a plurality of rules concurrently across a plurality of parallel processors of the network processing unit.

12. The method of claim 11, further comprising:
dynamically assigning the events to respective processors.

13. The method of claim 12, further comprising:
executing the actions of true rules in an event sequentially.

14. The method of claim 13, further comprising:
executing multiple instances of the same event concurrently.

15. A method of using a virtual machine on parallel processors of a network processing unit for processing IP packets, comprising:
providing a virtual machine adapted for association with a network processing unit, the virtual machine adapted to interpret packet processing bytecode into binary code readable by the network processing unit, wherein the packet processing bytecode comprises:
policies comprising one or more packet processing functions;
rules comprising one or more expressions and actions adapted to apply the policies; and
events comprising one or more rules; and
executing a plurality of rules concurrently across the parallel processors of the network processing unit.

16. The method of claim 15, further comprising:
dynamically assigning the events to respective processors.

17. The method of claim 16, further comprising:
executing the actions of true rules in an event sequentially.

18. The method of claim 17, further comprising:
executing multiple instances of the same event concurrently.

19. A method for programming a network processing unit for packet processing using a virtual machine, comprising:
creating a bytecode using a packet processing language adapted for creating bytecode readable by a compiler;
compiling the bytecode written in packet processing language into binary code readable by the virtual machine; and
loading the binary code onto the virtual machine associated with the network processing unit.

20. The method of claim 19, wherein creating a bytecode using a packet processing language adapted for creating bytecode readable by a compiler comprises creating a bytecode using a packet processing language adapted for creating bytecode readable by a compiler, the packet processing language comprising:
policies comprising one or more packet processing functions;
rules comprising one or more expressions and actions adapted to apply the policies; and
events comprising one or more rules.
